(19) United States
(12) Patent Application Publication
(10) Pub. No.: US 2016/0112488 A1
(43) Pub. Date: Apr. 21, 2016

(54) Providing Information of Data Streams

(71) Applicant: SSH Communications Security OYJ, Helsinki (FI)

(72) Inventor: Kenneth Oksanen, Helsinki (FI)

(21) Appl. No.: 14/517,992

(22) Filed: Oct. 20, 2014

(51) Int. Cl. H04L 29/06; H04L 29/12

(52) U.S. Cl. CPC H04L 65/607; H04L 63/1408; H04L 61/6022

(57) ABSTRACT

Methods and apparatuses for processing information of data streams in a data network are provided. In accordance with a method comprising at least one first stream of data is determined in accordance with a first protocol. A second stream of data is then generated in accordance with a second protocol, wherein the second protocol is a lower layer protocol than the first protocol. The generating comprises including at least a portion of the determined at least one first stream of data in the second stream of data and encoding into a predefined control information field of the second stream of data information associated with the at least one first stream of data for use in processing the at least one first stream of data. The recipient can then use the encoding in processing the at least one data stream.

### FIELD OF THE INVENTION

This disclosure relates to communications in a computerized system, and more particularly to providing information associated with one or more data streams in accordance with a protocol.

### BACKGROUND

Monitoring of data communications in a computerised network can be provided for various reasons. The monitoring creates data that can be used e.g. for defensive, analytical and audit purposes and/or for preventing loss of data. For example, large organizations such as businesses, governmental or municipal organizations or non-profitable organizations may wish to monitor the use and access to their internal computer systems. A network system and communications therein can be constantly monitored to protect the system from attacks by external users and data leaks or other unauthorised data communications and/or to prevent data loss. Monitoring systems are developing from analysing individual packets towards deeper analysis which entails reconstructing a stream of data. A stream of data can be for example a transport control protocol/internet protocol (TCP/IP) stream carried by individual Ethernet packets.

An example of monitoring systems is an intrusion detection system (IDS). An intrusion detection system can listen e.g. to Ethernet packets to detect data leaks and malicious attacks. An intrusion detection system is a passive observer and cannot itself delve into an encrypted connection, for example a security protocol connection such as a connection based on the Secure Shell (SSH) protocol. Various solutions such as jump servers and other advanced products have been developed to enable monitoring of encrypted connections. These can be based e.g. on “man-in-the-middle” (MITM) and/or key escrow type solutions where an intermediate device can take the contents of an encrypted connection flowing there through and decrypt it into plaintext and enclose the captured content in plaintext into generated synthetic Ethernet IP TCP-packets. This generated stream of data packets is then communicated to a separate IDS entity for analysis. It is noted that not all monitoring arrangements need to perform decryption. For example, the monitored traffic can also be plaintext.

A problematic situation may occur where additional information of the captured data flow would be desired by the entity receiving the generated report stream. In accordance with an exemplifying scenario a MITM entity can capture a multichannel data flow where a number of streams of data carried in different channels are multiplexed in the data flow. An example of this is where packets in accordance with the SSH protocol contain a “channel” field which allows multiplexing several data channels into the same SSH connection. The multiple channels can even comprise data for different kinds of traffic, such as secure file transfer protocol (SFTP) and terminal traffic. On the other hand, the lower level transport protocols commonly used for reporting by the data capturing entity to the analysing entity, such as TCP/IP protocol, may not have the equivalent capability. Consequently, should e.g. a captured SSH connection employ multiple channels, the IDS cannot be provided with sufficient information for enabling it to demultiplex the individual data channels correctly for deeper inspection.

It is noted that the above discussed issues are not limited to any particular communication protocol and data processing apparatus but may occur in any system where information of communications in accordance with a protocol may need to be communicated based on another protocol. For example, instead of an IDS, an access auditing or another data analysis and/or protection system may be provided with a copy of a data flow and information associated therewith so that the data therein can be analysed.

Embodiments of the invention aim to address one or several of the above issues.

### SUMMARY

In accordance with an aspect there is provided a method for communicating information in a data network, the method comprising determining at least one first stream of data in accordance with a first protocol and generating a second stream of data in accordance with a second protocol, wherein the second protocol is a lower layer protocol than the first protocol and the generating comprises including at least a portion of the determined at least one first stream of data in the second stream of data and encoding into a predefined control information field of the second stream of data information associated with the at least one first stream of data for use in processing the at least one first stream of data.

In accordance with an aspect there is provided a method for receiving information regarding at least one first stream of data according to a first protocol, the method comprising receiving a second stream of data in accordance with a second protocol and including at least a portion of the least one first stream of data, wherein the second protocol is a lower layer protocol than the first protocol and the second stream of data includes an encoding of information associated with the at least one first stream of data in a predefined control information field and processing the at least one first stream of data based on said information in the predefined control information field of the second stream of data.

In accordance with another aspect there is provided an apparatus for providing information associated with data streams, the apparatus comprising at least one processor, and at least one memory including computer program code, wherein the at least one memory and the computer program code are configured, with the at least one processor, to cause the apparatus to determine at least one first stream of data in accordance with a first protocol and generate a second stream of data in accordance with a second protocol, wherein the second protocol is a lower layer protocol than the first protocol and the apparatus includes at least a portion of the determined at least one first stream of data in the second stream of data and encodes into a predefined control information field of the second stream of data information associated with the at least one first stream of data for use in processing the at least one first stream of data.

In accordance with a yet another aspect there is provided an apparatus for processing at least one first stream of data according to a first protocol, the apparatus comprising at least one processor, and at least one memory including computer program code, wherein the at least one memory and the computer program code are configured, with the at least one processor, to cause the apparatus to receive a second stream of data in accordance with a second protocol including at least a portion of the least one first stream of data, wherein the second protocol is a lower layer protocol than the first protocol and the second stream of data includes in a predefined control information field an encoding of information associated with the at least one first stream of data and process the at least one first stream of data based on said information in the predefined control information field of the second stream of data.

In accordance with a more detailed aspect at least two first streams of data multiplexed in a data flow in accordance with the first protocol are determined. Information for distinguishing the determined at least two first streams of data is encoded into the predefined control information field of the second data stream. The first data streams can associate with respective channels of the data flow and channel identity information can be encoded into the predefined control information field for use in demultiplexing the first data streams from the generated second data stream. The predefined field can comprise at least one of a destination address field, a source address field, an options field, and a port number field in accordance with the lower layer protocol. In accordance with an aspect the predefined field comprises a media access control (MAC) destination address field or a media access control (MAC) source address field.

An intermediate entity can capture at least one first stream of encrypted data and decrypt the captured encrypt data for sending in plaintext form in the second data stream to a data analyser entity.

According to an embodiment an intermediate entity captures the at least one first stream of data, sends the generated second data stream to a data analyser entity with information identifying the at least one first data stream being encoded in the predefined control information field, stores information in a database for the at least one first data stream, receives information identifying the at least one first data stream from the data analyser entity, and fetches the stored information based on the received information identifying the at least one first data stream. The analyser entity can be configured to, after reception of the second stream of data, determine irregularity in at least one first stream of data included in the second stream of data and identified based on information in the predefined control information field. The analyser can then send the information identifying the determined at least one first data stream for use in fetching information stored in a database for the determined at least one first data stream.

An indication of a virtual local area network can be encoded into the predefined field.

The first protocol can be based on a security protocol and the second protocol can be based on Transport Control Protocol/Internet Protocol (TCP/IP). Certain more detailed aspects are evident from the detailed description.

### SUMMARY OF THE DRAWINGS

Various exemplifying embodiments of the invention are illustrated by the attached drawings. Steps and elements may be reordered, omitted, and combined to form new embodiments, and any step indicated as performed may be caused to be performed by another device or module. In the Figures

FIG. 1 illustrates an example of a data network setup where the invention can be embodied;

FIGS. 2 and 3 show flowcharts in accordance with certain embodiments; and

FIG. 4 shows data processing apparatus.

### DETAILED DESCRIPTION

Certain embodiments relating to providing information of at least one stream of data based on use of a lower layer protocol control information field of another stream of data are described below to illustrate the invention. In accordance with a particular example at least two streams of data in respective channels are multiplexed in accordance with a protocol in a data flow routed through a network entity, and information for enabling analysis or other processing of the multiplexed data is included in a header field of a stream of data generated in accordance with a second, lower level protocol.

It is noted that in the following specific disclosure the term stream refers to a flow of data. A stream can be carried in a channel. Multiple of channels can be multiplexed into one data flow, each channel being identified by a channel identifier, for example a channel number. Channel information can refer to any information associated with the channel and useful in further processing of the data carried by the channel, for example the channel number as such. Channel information can also refer e.g. to any derived value able to distinguish the channel with sufficient accuracy for it to be useful for operation by an entity receiving the information.

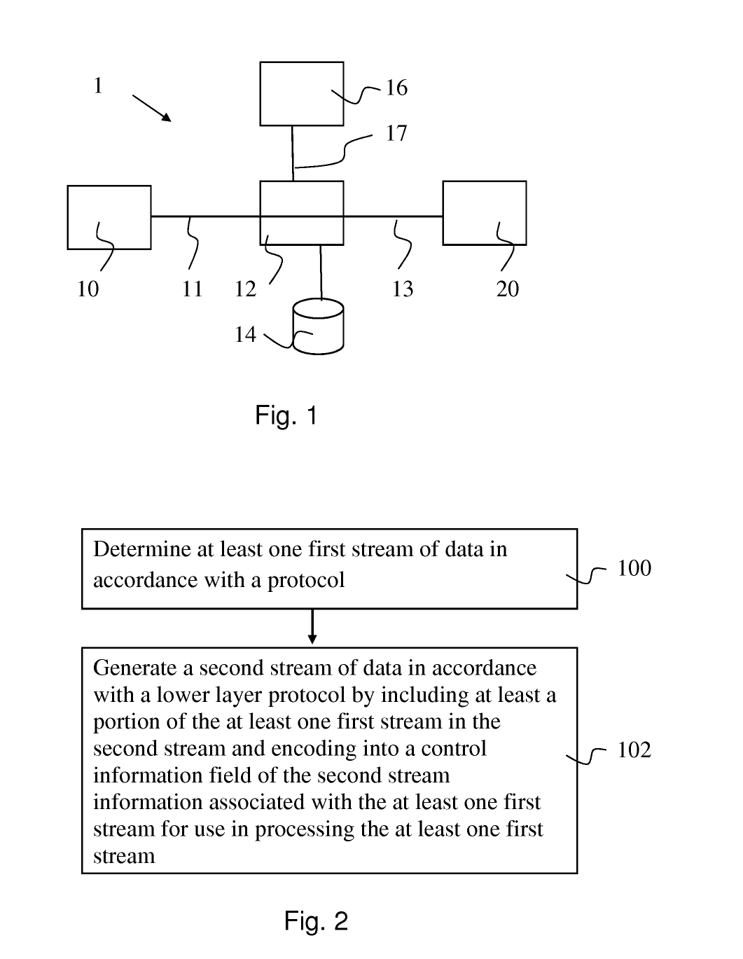

FIG. 1 shows an example of a data network system 1 where the herein described principles may be embodied. The data network can be for example an Intranet of an enterprise or similar organisation. The network can be e.g. an IPv4 or IPv6 based network. A client device 10 is shown to have a communication connection via links 11 and 13 with a server 20. The link can be provided via fixed line connection. It is possible that at least a part of the connection is provided over a wireless interface. For example, the client device may be provided wireless access to the communication network. A wireless connection to the network can be provided via a base station based on e.g., wireless local area network (WLAN), GSM/EDGE/HSPA, 3G, 4G, 5G, or WiMAX standards, and/or optical and near-field networks, or any future development of wireless standards.

Communication session between the devices flow though an intermediate data processing device 12. The intermediate data processing device 12 hosts a data capturing entity configured to monitor traffic going there through and capture and forward data to another entity. Thus data communicated between the client device 10 and the server device 20 can be captured by the intermediate data processing device 12.

At least a part of data flowing through the intermediate entity may be encrypted. In such case the intermediate data processing device can be configured to provide a man-in-the-middle (MITM) type operation on encrypted data flowing there through to obtain the plaintext of the data. The MITM operation involves decryption of encrypted data. This would typically be based on knowledge of the private key used in the encryption. The data capturing intermediate device 12 is operated and maintained by a trusted patty, typically the owner of the network, and can thus be provided with the necessary keys and/or other security information required for the decryption.

It is noted that this is only an example and that the shown architecture and/or MITM type operation is not necessary in all scenarios. For example, the monitored passing data flow can also be plaintext, for example plaintext TCP communications. Instead of the shown arrangement other network arrangements and modes are also possible. For example, interfaces 11 and 13 can be in a bastion mode.

In accordance with an embodiment substantially all data of a session captured by entity 12 can be sent to a separate server. In accordance with other embodiments it is sufficient if only some of the captured data is sent. In some embodiments sending may be selective, and thus only e.g. information about which files are accessed through the session may be sent without sending the actual file contents. For example, a signature-based IDS or DLP system can be provided even if the system only receives samples of the traffic. On the other hand, systems performing deep analysis may expect to receive most if not all data of a given channel.

A data capture component can be provided as a standalone hardware component or embedded in another element, e.g. in a firewall or the like component. The data capturer can also be provided as a virtual machine set up in cloud computing environment. A firewall may contain one or more protocol proxies, such as an SSH proxy, remote desktop protocol (RDP) proxy, virtual network computing (VNC) proxy, file transfer protocol/secure (FTP/S; FTP over Secure Sockets Layer (SSL), Transport Layer Security (TLS) protocols) proxy, or HTTP/S (HTTP over SSL/TLS) proxy. A proxy may also implement more than one protocol. Each proxy can contain a man-in-the-middle component for performing man-in-the-middle operation, or key escrow or other suitable method, for obtaining access to the plaintext of the session.

The intermediate data processing entity is further connected by link 17 to a separate processing device 16 in the network. The separate device 16 is configured for analysis and/or other processing of the data captured by the intermediate entity 12. In accordance with a particular example the receiving device provides an Intrusion Detection System (IDS). The link 17 can be provided based on various protocols. In accordance with an example described below a synthetic TCP/IP based connection is provided.

Link 17 can be provided on the data link layer of the seven-layer Open Systems Interconnection (OSI) model of computer networking. The data link layer is provided on layer 2 of the OSI model. Thus the protocol can be a lower layer protocol than the protocol used for the communication sessions between devices 10 and 20. The data link layer is concerned with local delivery of frames between devices on the same local area network (LAN). Protocol data units of this layer do not cross the boundaries of the local network. The data link layer is thus typically used for data transfers between adjacent network nodes in a wide area network or between nodes on the same local area network segment. Examples of data link protocols are the Ethernet for local area networks (multi-node), the Point-to-Point Protocol (PPP), High-Level Data Link Control (HDLC) and Advanced Data Communication Control Procedures (ADCCP) for point-to-point (dual-node) connections.

Inter-network routing and global addressing are higher layer functions whereas lower layer data-link protocols focus on local delivery, addressing, and media arbitration. For example media access control (MAC) data communication protocol can be used for these purposes. MAC is a sublayer of the data link layer (OSI layer 2) in the seven layer open systems interconnection (OSI) model. The MAC sublayer provides addressing and channel access control mechanisms that enable several terminals or network nodes to communicate within a multiple access network that incorporates a shared medium, for example the Ethernet.

The communications between the client device 10 and the server device 12 can be based on any appropriate higher level protocol. In accordance with an example the higher layer protocol provides at least some level of security on the communications. The higher layer protocol may enable multichannel communications wherein different data streams in respective channels are multiplexed into a single data flow. For example, multiplexed encrypted protocols can be provided based on Secure Shell (SSH) protocol, Multiplexed Transport Layer Security (MTLS) protocol where several channels are multiplexed in one TLS session and remote desktop protocols, like RDP.

Multiplexing can be problematic since an entity that is supposed to process and analyse the multiplexed data may only receive a single stream of data because of the limitations of the lower layer protocol. Thus it is not necessarily capable of distinguishing between packets belonging to different data channels multiplexed into a data flow between the client device 10 and the server device 20. Thus the received data cannot necessarily be processed properly to reconfigure the original streams of data in respective channels.

This shortcoming can be addressed by including details of the upper level protocol (e.g. information on SSH channels) to lower level protocol headers. By means of this a mechanisms for conveying information in a relatively simple manner can be provided instead of designing and standardizing additional protocols.

In accordance with embodiment shown in the flowchart of FIG. 2 processing of the data is enabled by sending additional information regarding the captured or otherwise determined stream(s) of data to the receiving entity. More particularly, in step 100 the intermediate entity determines at least one first stream of data in accordance with a first protocol. A second stream of data is then generated at 102 in accordance with a second protocol. The second protocol is a lower layer protocol than the first protocol. The generating comprises including at least a portion of the determined at least one first stream of data in the second stream of data and encoding into a predefined control information field of the second stream of data information associated with the at least one first stream of data for use in processing the at least one first stream of data.

For example, a data processing entity can be configured to report additional information regarding multiplexed communications such as an indication that the data stream comprises data from multiple data streams. The intermediate data processing entity can provide information distinguishing between the different streams of data in a multiplexed data flow and/or other information associated with the at least one captured stream of data for use in analysis of data communicated in a multiplexed stream. The determining can comprise capturing at least one stream of data that is multiplexed in a data flow flowing through the intermediate entity in accordance with a first protocol.

According to a possibility in addition to or instead of channel information other information associated with at least one determined stream is encoded in headers of data packets of the lower protocol communications. The information can be any information useful in analysis of the data. For example, initial packets of a synthetic TCP-stream can carry other information about the opened channels, e.g. a ‘channel type’ string, unreplaced channel number(s), user names etc. Thus, in addition to information identifying a data stream and useful e.g. in separating multiplex data streams from each other, any other information associated with a session where at least one data stream can be determined can be communicated in one or more lower level control information fields. In principle any information that can be used by a device performing forensic analysis on a data stream captured by another entity can be encoded in the lower level control fields of packets of the second stream.

The predefined control field can be an appropriate header field of the lower layer protocol data unit. In accordance with an example the predefined field comprises a lower layer address field for the destination address of the generated data stream. For example, a media access control (MAC) protocol destination address field can be used for conveying information for distinguishing between different data streams, for conveying other additional information regarding the captured data. For example, a MAC destination address has redundant bits that can be used for conveying the additional information. It is not necessary to use the entire MAC field but only a part of it. The size of MAC address field is 48 bits while e.g. in the SSH the channel number is 32 bits. Thus the 24-bit network interface controller (NIC) part of the MAC address is sufficient to store the channel information in most if not all practical scenarios.

Other examples include the source address field, port number field and option field of lower layer messages.

According to an advantageous implementation the lower level protocol address field comprises the receiver/destination media access control (MAC) address, e.g. Ethernet MAC destination address. Use of the destination MAC address field can be advantageous since the receiver of the generated data stream can be in promiscuous mode and listen to all Ethernet packets in the network. Thus the destination MAC address is, or can be configured to be, redundant and the field is available in its entirety for this use. E.g. an IDS or other entity needing information for e.g. security analysis can be configured to listen “promiscuously” to all network packets. Thus the channel identities of the multiplexed channels can be encoded in a desired part of the destination MAC address without endangering the delivery of the packet.

If the source address fields are used for conveying the information it may be necessary to ensure that these fields are not overwritten by other devices or software components on the route to the recipient device.

The monitored protocol can be any protocol. It is currently believed that particular advantage can be obtained in connection with security protocols, for example the SSH, as these can be difficult if not impossible for external analysers to process without the channel information.

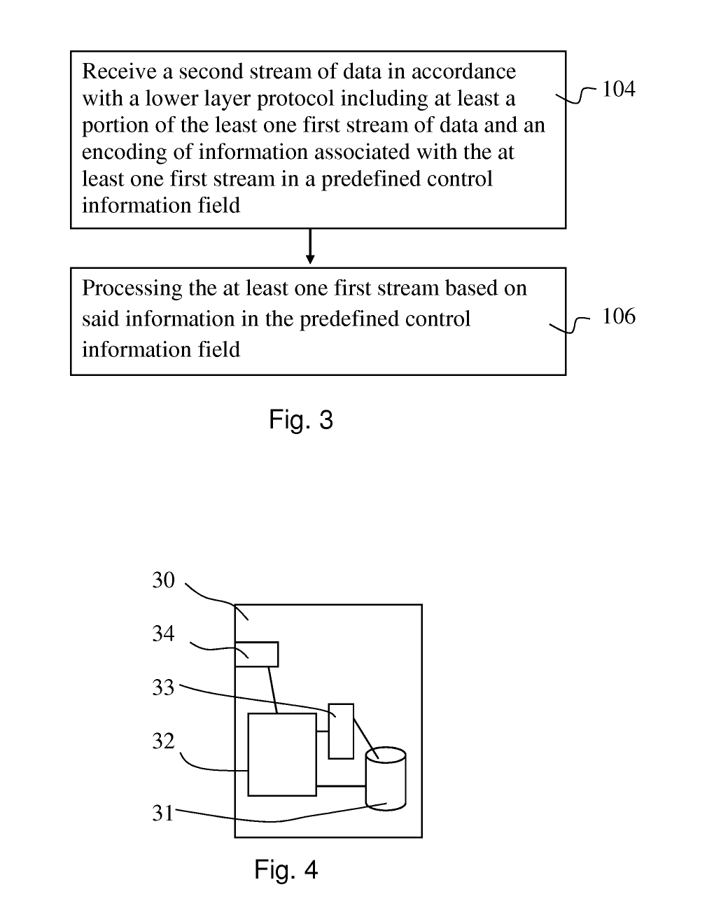

FIG. 3 shows a flow chart illustrating the operation at an entity receiving data and additional information. For example, an intrusion detection system (IDS) or other security system entity can be configured to analyse data received e.g. from a capturer of at least one first stream of data. In step 104 the entity receives a second stream of data in accordance with a second protocol, the second protocol being a lower layer protocol than the first protocol. The second stream of data includes at least a portion of the at least one first stream of data. Further, an encoding of information associated with the at least one first stream of data is included in a predefined control information field. At 106 the at least one first stream of data is processed based on said information in the predefined control information field of the second stream of data.

In accordance with an embodiment information of multichannel data streams is coded in communications in accordance with a second protocol such that channel information is used to identify at least one channel in the multiplexed flow of information. For example, the at least one stream of data can be captured by a capturer entity from a multiplexed data flow. The encoding can comprise information identifying the at least one stream of data in a predefined lower layer control information field. The receiving entity obtains from the predefined control information field information identifying the at least one stream of data so that the entity can demultiplex the data back into original data streams based on channel information identifying the packets belonging to the respective streams. The channel information can be transferred coded in a lower layer address field replacing the lower layer address. Alternatively, the channel information is included in addition to the lower level address information.

The recipient can be configured to detect from the contents of the predefined address field that it contains additional information. For example, it can be detected that the report data stream comprises multiple captured data streams and identities of these streams.

In accordance with a possibility an Organizationally Unique Identifier (OUI) is used for indicating existence of multiple data streams or other control information in the address field. In an OUI the first three octets (in transmission order) identify the organization that issued the identifier and are thus vendor specific. The MAC address comprises also a 3-byte network interface controller (NIC). There is a centralized process of registering OUI's to vendors and there are many OUI's (E.g. the applicant's OUI is 00:03:80). The NIC is, however, controlled by the particular vendor, and can be anything. Therefore a possibility is to encode channel information so that a (practically) non-existing OUI is chosen and the channel information is encoded in the bytes reserved for the NIC.

The information encoded e.g. into the MAC address or other header does not need to equal to the actual channel number. It may also be a synthetic value as long as it sufficient to separate between distinct channels. For example, a running counter can be provided. A renumbering of the actual channel numbers to another scheme may be desired to allow for a reasonably narrow address range which does not collide with any actually occurring address in the local network. The information identifying a stream of data and tying the communicated number to the actual number can be provided for example based on appropriate mapping tables. There may not need to be a one-to-one mapping from channel information to all possible channel numbers just sufficient enough for practical uses.

In accordance with a further embodiment information regarding a Virtual LAN tag is encoded into the MAC address in case the SSH connection is over a different Virtual LAN than the IDS connection. This information can be provided in addition to the channel information. This can be advantageous e.g. in scenarios where interfaces 11 and 13 are used for transmission of data of different virtual local areas networks (LANs) and where this information would be advantageous if provided for the processing entity 16.

In the above examples the address fields were utilised. Encoding the channel information into a TCP options-field in a TCP packet header is also a feasible option. This option may require standardisation and market adoption before IDS devices and the like can support it.

A probabilistic approach to encode the channel information into port number fields may also be provided. In this example the port numbers are replaced with a hash (salted e.g. with a SSH session-specific initial value) and possibly excluding ranges of reserved port numbers.

A further embodiment will now be described with reference to a database 14 of FIG. 1. The database is for storing information of data streams passing through the intermediate data processing device 12. For example, the device 12 can be configured to store a copy of any communications passing there through. In accordance with a further embodiment the information identifying the at least one data stream for the analysis device such as the IDS can be used for other purposes. The intermediate data processing device can be arranged to store the data streams or at least portions thereof, or information enabling tracking the data streams into a database. Such a database is illustrated as database 14 in FIG. 1. When storing the information into the database, the stored data can be identified based on the same identifying information as is used for identifying the data streams for the analysis device 16.

According to a possibility an identifier that can be mapped based on the identifier communicated to device 16 is used in response to determining that further action on data communicated though the capturer entity 12. When IDS entity of device 16 detects an irregularity it can communicate back to entity 12 the information identifying the data stream. The entity 12 can then easily retrieve the original data stream from the database 14. Thus the data stream which is associated with suspicious activity detected by the analyser device can be easily and quickly obtained from the database of the intermediate device 12 without any further look-up of searches. Use of synthetic values such as specifically created channel identifiers instead of actual channel numbers may provide more powerful searches from the database 14.

Use of the existing control information fields of a protocol for communicating the information associated with the determined data stream is advantages also for the reason that this requires no further standardisation as the fields are already in place and it is only required that the sender and recipient understand the additional information therein. In certain embodiments the entire information content of a controlled information field is replaced and in some others additional information is included using surplus bits in the field.

Sending of additional information of multiplexed data streams can be particularly advantageous when processing compressed data streams.

FIG. 4 shows an example of control apparatus for providing an entity capable of processing the above described messages. The control apparatus 30 can be for example integrated with, coupled to and/or otherwise for controlling the intermediate entity 12 of FIG. 1 and/or the analysis device 16. The control apparatus 30 can be arranged to provide control on communications of the captured data and the additional information. The control apparatus 30 can be configured to provide control functions in association with operations such as determining the at least one data stream, encryption thereof, encoding the additional information into a second data stream, signalling and data communication operations. Likewise, at the receiving device an apparatus cam receive the data stream and obtain the additional information for enabling processing of the data flowing through the intermediate entity. For this purpose the control apparatus comprises at least one memory 31, at least one data processing unit 32, 33 and an input/output interface 34. Via the interface the control apparatus can be coupled to the transport entities of the respective device. The control apparatus can be configured to execute an appropriate software code to provide the control functions. The control apparatus can also be interconnected with other control entities.

Different means than described herein can also be used for implementing the various functions.

The various embodiments and their combinations or subdivisions may be implemented as methods, apparatuses, or computer program products. Methods for downloading computer program code for performing the same may also be provided. Computer program products may be stored on non-transitory computer-readable media, such as memory chips, or memory blocks implemented within the processor, magnetic media such as hard disk or floppy disks, and optical media such as for example DVD and the data variants thereof, CD, magnetic disk, or semiconductor memory. Method steps may be implemented using instructions operable to cause a computer to perform the method steps using a processor and a memory. The instructions may be stored on any computer-readable media, such as memory or non-volatile storage.

In accordance with an embodiment there is provided a non-transitory computer readable media comprising program code for causing a processor to perform instructions for determining at least one first stream of data in accordance with a first protocol and generating a second stream of data in accordance with a second protocol, wherein the second protocol is a lower layer protocol than the first protocol and the generating comprises including at least a portion of the determined at least one first stream of data in the second stream of data and encoding into a predefined control information field of the second stream of data information associated with the at least one first stream of data for use in processing the at least one first stream of data.

In accordance with an embodiment there is provided a non-transitory computer readable media comprising program code for causing a processor to perform instructions for receiving a second stream of data in accordance with a second protocol and including at least a portion of at least one first stream of data, wherein the second protocol is a lower layer protocol than the first protocol and the second stream of data includes an encoding of information associated with the at least one first stream of data in a predefined control information field and processing the at least one first stream of data based on said information in the predefined control information field of the second stream of data.

The required data processing apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The foregoing description provides by way of exemplary and non-limiting examples a full and informative description of exemplary embodiments of the s invention. However, various modifications and adaptations may become apparent to those skilled in the relevant arts in view of the foregoing description, when read in conjunction with the accompanying drawings and the appended claims. For example, a data capturing entity and data processing entity can be provided in a single service. Also, it is possible to masquerade SFTP file transfers as HTTP GET/PUT or requests and encode channel information or other relevant information in synthesized HTTP headers. However, numerous other possibilities exist. All such and similar modifications of the teachings of this invention will still fall within the spirit and scope of this invention.

We claim:

1. A method for communicating information in a data network, the method comprising
determining at least one first stream of data in accordance with a first protocol, and
generating a second stream of data in accordance with a second protocol, wherein the second protocol is a lower layer protocol than the first protocol and the generating comprises
including at least a portion of the determined at least one first stream of data in the second stream of data, and
encoding into a predefined control information field of the second stream of data information associated with the at least one first stream of data for use in processing the at least one first stream of data.

2. The method according to claim 1, comprising determining at least two first streams of data multiplexed in a data flow in accordance with the first protocol, and encoding information for distinguishing the determined at least two first streams of data into the predefined control information field of the second data stream.

3. The method according to claim 2, wherein the first data streams are included in respective channels of the data flow, the method comprising encoding channel identity information into the predefined control information field for use in demultiplexing the first data streams from the generated second data stream.

4. The method according to claim 1, wherein the predefined field comprises at least one of a destination address field, a source address field, an options field, and a port number field in accordance with the lower layer protocol.

5. The method according to claim 1, wherein the predefined field comprises one of a media access control (MAC) destination address field and a media access control (MAC) source address field.

6. The method according to claim 1, wherein the determining comprises capturing by an intermediate entity at least one first stream of encrypted data and the generating comprises decrypting the captured encrypt data for sending in plaintext form in the second data stream to a data analyser entity.

7. The method according to claim 1, comprising
capturing by an intermediate entity the at least one first stream of data,
sending the generated second data stream to a data analyser entity with information identifying the at least one first data stream being encoded in the predefined control information field,
storing information in a database for the at least one first data stream,
receiving information identifying the at least one first data stream from the data analyser entity, and
fetching the stored information based on the received information identifying the at least one first data stream.

8. The method according to claim 1, comprising encoding an indication of a virtual local area network into the predefined field.

9. The method according to claim 1, wherein the first protocol is based on a security protocol and the second protocol is based on Transport Control Protocol/Internet Protocol (TCP/IP).

10. A method for receiving information regarding at least one first stream of data according to a first protocol, the method comprising
receiving a second stream of data in accordance with a second protocol and including at least a portion of the least one first stream of data, wherein the second protocol is a lower layer protocol than the first protocol and the second stream of data includes an encoding of information associated with the at least one first stream of data in a predefined control information field, and
processing the at least one first stream of data based on said information in the predefined control information field of the second stream of data.

11. The method according to claim 10, comprising distinguishing at least two first streams of data multiplexed in a data flow in accordance with the first protocol based on the encoding of information in the predefined control information field of the second data stream.

12. The method according to claim 11, wherein the first data streams are included in respective channels of the data flow, the method comprising demultiplexing the first data streams based on encoding of channel identity information in the predefined control information field.

13. The method according to claim 10, wherein the predefined field comprises one of a destination address field, a source address field, an options field, and a port number field in accordance with the lower layer protocol.

14. The method according to claim 10, wherein the predefined field comprises one of a media access control (MAC) destination address field and a media access control (MAC) source address field.

15. The method according to claim 10, comprising detecting that an address field of a received packet comprises information associated with a multiplexed data flow.

16. The method according to claim 10, comprising
receiving the second stream of data from an intermediate data capture entity at a data analyser entity,
determining irregularity in at least one first stream of data included in the second stream of data identified based on information in the predefined control information field, and
sending the information identifying the determined at least one first data stream for use in fetching information stored in a database for the determined at least one first data stream.

17. An apparatus for providing information associated with data streams, the apparatus comprising at least one processor, and at least one memory including computer program code, wherein the at least one memory and the computer program code are configured, with the at least one processor, to cause the apparatus to
determine at least one first stream of data in accordance with a first protocol, and
generate a second stream of data in accordance with a second protocol, wherein the second protocol is a lower layer protocol than the first protocol and the apparatus includes at least a portion of the determined at least one first stream of data in the second stream of data and encodes into a predefined control information field of the second stream of data information associated with the at least one first stream of data for use in processing the at least one first stream of data.

18. The apparatus according to claim 17, configured to determine at least two first streams of data multiplexed in a data flow in accordance with the first protocol and encode information for distinguishing the determined at least two first streams of data into the predefined control information field of the second data stream.

19. The apparatus according to claim 18, wherein the first data streams are associated with respective channels of the data flow, the apparatus being configured to encode channel identity information into the predefined control information field for use in demultiplexing of the first data streams from the second data stream.

20. The apparatus according to claim 17, wherein the predefined field comprises at least one of a destination address field, a source address field, an options field, and a port number field in accordance with the lower layer protocol.

21. The apparatus according to claim 17, wherein the predefined field comprises one of a media access control (MAC) destination address field and a media access control (MAC) source address field.

22. The apparatus according to claim 17, comprising an intermediate entity configured further to capture encrypted data and decrypt the captured encrypt data for sending in plaintext form in the second data stream to a data analyser entity.

23. The apparatus according to claim 17, comprising an intermediate entity configured to
capture the at least one first stream of data,
communicate the generated second data stream to a data analyser entity with information identifying the at least one first data stream,
store information in a database for the at least one first data stream,
receive information identifying the at least one first data stream from the data analyser entity, and
fetch the stored information from the database based on the received information identifying the at least one first data stream.

24. An apparatus for processing at least one first stream of data according to a first protocol, the apparatus comprising at least one processor, and at least one memory including computer program code, wherein the at least one memory and the computer program code are configured, with the at least one processor, to cause the apparatus to
receive a second stream of data in accordance with a second protocol including at least a portion of the least one first stream of data, wherein the second protocol is a lower layer protocol than the first protocol and the second stream of data includes in a predefined control information field an encoding of information associated with the at least one first stream of data, and
process the at least one first stream of data based on said information in the predefined control information field of the second stream of data.

25. The apparatus according to claim 24, configured to distinguish at least two first streams of data multiplexed in a data flow in accordance with the first protocol based on encoding of information in the predefined control information field of the second data stream.

26. The apparatus according to claim 25, wherein the first data streams associate with respective channels of the data flow, the apparatus being configured to demultiplex the first data streams based on the encoding of channel identity information.

27. The apparatus according to claim 24, wherein the predefined field comprises one of a media access control (MAC) destination address field and a media access control (MAC) source address field.

28. The apparatus according to claim 24, configured to detect whether an address field of a received packet comprises information associated with a multiplexed data flow.

29. The apparatus according to claim 24, comprising a data an analyser entity configured to
receive the second stream of data from an intermediate data capture entity,
determine irregularity in at least one first stream of data included in the second stream of data and identified based on information in the predefined control information field, and
send the information identifying the determined at least one first data stream for use in fetching information stored in a database for the determined at least one first data stream.
